(19) United States
(12) Patent Application Publication
(10) Pub. No.: US 2007/0189556 A1
(43) Pub. Date: Aug. 16, 2007

(54) Condenser microphone and method of producing the same

(75) Inventor: Yuki Tsuchiya, Fujiyoshida-shi (JP)

Correspondence Address: BRINKS HOFER GILSON & LIONE, P.O. BOX 10395, CHICAGO, IL, 60610, US

(73) Assignee: CITIZEN ELECTRONICS CO., LTD.

(21) Appl. No.: 11/699,915

(22) Filed: Jan. 30, 2007

(30) Foreign Application Priority Data
Feb. 1, 2006 (JP) JP2006-024140

(51) Int. Cl. H04R 25/00

(52) U.S. Cl. 381/174

(57) ABSTRACT

A condenser microphone with a novel structure has a stack of an electronic circuit board (16a), a backplate substrate (13a) having a backplate (14), a spacer (10a), and a diaphragm support frame (1a) supporting a diaphragm (2) so that the diaphragm faces the backplate across the spacer. The outer contours of the electronic circuit board, the backplate substrate and the spacer are the same in shape and size. The outer contour of the diaphragm support frame has portions coincident in shape and size with the outer contours of the electronic circuit board, the backplate substrate and the spacer and further has recesses formed on inward from the outer contours of the electronic circuit board, the backplate substrate and the spacer.

This application claims priority under 35 U.S.C. §119 to Japanese Patent Application No. JP2006-024140 filed Feb. 1, 2006, the entire content of which is hereby incorporated by reference.

### BACKGROUND OF THE INVENTION

1. Field of the Invention

The present invention relates to a compact condenser microphone that is widely usable in portable electronic devices such as cellular phones and so forth, and also relates to a method of producing the condenser microphone.

2. Description of the Related Arts

Electret condenser microphones using an electret dielectric film (hereinafter referred to as simply “condenser microphones”) have heretofore been employed in a wide variety of fields because they are simple in structure, easy to miniaturize and low in cost. In recent years, the condenser microphones have been used as microphones of cellular phones, for which demand has been increasing rapidly. Accordingly, it is demanded that the condenser microphones should become smaller in size, higher in performance and lower in cost.

FIG. 6(a) is a sectional view of a conventional condenser microphone 30. As illustrated in the figure, the condenser microphone 30 has an electronic circuit board 32 having an electronic element, e.g. an FET 31, mounted thereon. A backplate substrate 33, a spacer 34 and a diaphragm support frame 36 are successively stacked on the electronic circuit board 32 and bonded together. The backplate substrate 33 has a backplate 33a on the upper side thereof and is provided on the lower side thereof with a recess for accommodating the FET 31. The diaphragm support frame 36 has a diaphragm 35 stretched on the lower side thereof.

The spacer 34 and the backplate substrate 33 are provided with vias (not shown), etc. to allow the diaphragm 35 and the backplate 33a to be electrically connected to the electronic circuit board 32.

FIG. 6(b) shows a stacked component assembly 40 as an intermediate product before the above-described condenser microphone is made as an end product. More specifically, the stacked component assembly 40 is formed by successively stacking an electronic circuit board assembly 41, a backplate substrate assembly 42, a spacer assembly 43, and a diaphragm support frame assembly 44.

As shown in the figure, the diaphragm support frame assembly 44 is formed from a multiplicity of diaphragm support frames 36, each having a quadrangular outer contour. The diaphragm support frames 36 are integrally arrayed in a lattice in contact with each other. The diaphragm support frame assembly 44 has a sheet as a diaphragm stretched over the entire area of the lower side thereof. In FIG. 6(b), reference symbols 45x and 45y denote dividing lines between the mutually contacting diaphragm support frames 36. Similarly, the electronic circuit board assembly 41 is formed from a multiplicity of quadrangular electronic circuit boards 32 having the same outer size as that of the diaphragm support frames 36. The electronic circuit boards 32 are integrally arrayed in a lattice in contact with each other across dividing lines. The backplate substrate assembly 42 is formed from a multiplicity of quadrangular backplate substrates 33 having the same outer size as that of the diaphragm support frames 36. The backplate substrates 33 are integrally arrayed in a lattice in contact with each other across dividing lines. The spacer assembly 43 is formed from a multiplicity of quadrangular spacers 34 having the same outer size as that of the diaphragm support frames 36. The spacers 34 are integrally arrayed in a lattice in contact with each other across dividing lines.

The above-described condenser microphone is produced as shown in FIG. 7. That is, the stacked component assembly 40 is mounted on a dicing sheet 50 in such a manner that the surface of the diaphragm support frame assembly 44 is fixed to the dicing sheet 50. The stacked component assembly 40 set as stated above is cut by a dicing blade 51 in the stacking direction along the dividing lines 45x and 45y.

The above-described condenser microphone producing method can obtain a multiplicity of products at a time. Therefore, productivity increases, and cost reduction can be achieved. It is also possible to produce homogeneous components and hence easy to carry out quality control, which leads to an increase in yield.

An invention relating to the above-described condenser microphone producing method is disclosed, for example, in Japanese Patent Application Publication No. 2002-345092.

The conventional condenser microphone producing method suffers, however, from the following problems.

FIG. 8 is an enlarged sectional view showing the way in which the stacked component assembly 40 is cut to prepare the above-described condenser microphone. In FIG. 8, when the dicing blade 51 cuts the stacked component assembly 40 along the dividing lines 45x and 45y, the diaphragm support frame assembly 44, which is located at the bottom of the stacked component assembly 40, is pressed downward by shearing force applied by the dicing blade 51, together with the diaphragm 35 attached to the diaphragm support frame assembly 44. Consequently, the diaphragm support frame assembly 44 is likely to separate from the spacer assembly 43 near the dividing lines 45x and 45y.

FIG. 9 is a sectional view showing a condenser microphone in which the above-described separation has occurred. In such a condenser microphone 30, external contaminant such as water or dust is likely to enter a slight gap between the diaphragm 35 and the backplate substrate 33 during use, causing degradation of the performance and reliability of the condenser microphone.

Separation due to cutting is likely to occur particularly when a thin metal sheet such as a stainless steel sheet is used as a material constituting the diaphragm support frame assembly 44 to reduce the thickness and cost of the condenser microphone. When a stainless steel or other metal sheet is used as the material of the diaphragm support frame assembly 44, frictional heat is generated by friction between the dicing blade 51 and the diaphragm support frame assembly 44, which is a metal sheet, and the heat discharges the electric charge implanted in the electret layer on the backplate 33a formed on the backplate substrate assembly 42. Consequently, the sensitivity of the microphone lowers, and the performance thereof degrades.

### SUMMARY OF THE INVENTION

Accordingly, an object of the present invention is to provide a condenser microphone capable of solving the above-described problems, and also provide a method of producing the condenser microphone.

That is, the present invention provides a condenser microphone including an electronic circuit board, a backplate substrate having a backplate, a spacer, and a diaphragm support frame supporting a diaphragm so that the diaphragm faces the backplate, wherein the electronic circuit board, the backplate substrate, the spacer and the diaphragm support frame are successively stacked. The outer contours of the electronic circuit board, the backplate substrate and the spacer are the same in shape and size. The outer contour of the diaphragm support frame has portions coincident in shape and size with the outer contours of the electronic circuit board, the backplate substrate and the spacer and further has recesses positioned inside the outer contours of the electronic circuit board, the backplate substrate and the spacer.

Namely, in the condenser microphone according to the present invention, the outer contour of the diaphragm support frame has recesses as stated above. Therefore, even if the condenser microphone is formed from the above-described stacked component assembly by performing dicing with a dicing blade along the outer contour (dividing lines), the recessed portions of the diaphragm support frame will not contact the dicing blade. Accordingly, the recessed portions of the diaphragm support frame will not be pressed downward by shearing force of the dicing blade. Thus, it is possible to avoid the problem of separation of the diaphragm support frame from the spacer assembly.

Specifically, the arrangement may be as follows. The outer contours of the electronic circuit board, the backplate substrate and the spacer are quadrangular. The outer contour of the diaphragm support frame has four sides corresponding to the outer contours of the electronic circuit board, the backplate substrate and the spacer, and a predetermined number of recesses as stated above are formed along respective the four sides.

More specifically, the recesses may include four elongated recesses formed on respective said four sides each of which extends from a center of corresponding one of the four sides to near both ends of the corresponding one.

The diaphragm support frame may be made of a metal material such as a stainless steel.

In addition, the present invention provides a condenser microphone producing method including the steps of providing an electronic circuit board assembly having a multiplicity of quadrangular electronic circuit boards integrally arrayed in a lattice in contact with each other, and preparing a backplate substrate assembly having a multiplicity of quadrangular backplate substrates integrally arrayed in a lattice in contact with each other. Each of the backplate substrates has a backplate and has the same outer size as that of the electronic circuit boards. The method further includes the steps of preparing a spacer assembly having a multiplicity of quadrangular spacers integrally arrayed in a lattice in contact with each other, the spacers having the same outer size as that of the electronic circuit boards, and providing a diaphragm support frame assembly having a multiplicity of diaphragm support frames integrally arrayed in a lattice in contact with each other. The diaphragm support frame assembly has a diaphragm stretched over the entire area of one side thereof. Each of the diaphragm support frames has a quadrangular outer contour. The outer contour has portions coincident with the outer size of the electronic circuit board and has recesses positioned inside the outer contour of the electronic circuit board. The electronic circuit board assembly, the backplate substrate assembly, the spacer assembly and the diaphragm support frame assembly are successively stacked and bonded together in such a manner that dividing lines between the mutually contacting electronic circuit boards of the electronic circuit board assembly, dividing lines between the mutually contacting backplate substrates of the backplate substrate assembly, dividing lines between the mutually contacting spacers of the spacer assembly and dividing lines between the mutually contacting diaphragm support frames of the diaphragm support frame assembly align with each other in the stacking direction, thereby fabricating a stacked component assembly. The stacked component assembly is cut in the stacking direction along the dividing lines aligned with each other, thereby preparing a multiplicity of condenser microphones each having a stack of the quadrangular electronic circuit board, the quadrangular backplate substrate having a backplate, the quadrangular spacer, and the diaphragm support frame supporting a diaphragm so that the diaphragm faces the backplate.

According to the condenser microphone producing method of the present invention, each diaphragm support frame constituting the diaphragm support frame assembly has recesses along the outer contour thereof. Therefore, even if the stacked component assembly is cut as stated above, the recessed portions of the diaphragm support frame will not be pressed downward by shearing force of the dicing blade 51. Accordingly, it is possible to avoid the problem of separation of the diaphragm support frame from the spacer assembly.

Specifically, the condenser microphone producing method may further include the steps of preparing a dicing sheet, mounting the stacked component assembly on the dicing sheet in such a manner that an exposed side surface of the diaphragm support frame assembly of the stacked component assembly is fixed to the dicing sheet, and cutting the stacked component assembly mounted on the dicing sheet with a dicing blade set to extend in the stacking direction on the dividing lines by forcing the dicing blade through the stacked component assembly toward the dicing sheet in the stacking direction.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is an exploded perspective view of a stacked component assembly prepared as an intermediate product for making a condenser microphone according to the present invention.

FIG. 2 is a top plan view showing a part of a diaphragm support frame assembly forming the topmost layer of the intermediate product shown in FIG. 1.

FIG. 3(a) is a perspective view of the stacked component assembly shown in FIG. 1.

FIG. 3(b) is a perspective view of the condenser microphone according to the present invention formed by cutting the stacked component assembly shown in FIG. 3(a).

FIG. 4 is a fragmentary sectional view of a part of the stacked component assembly, showing the relationship between a dicing blade and the stacked component assembly when the stacked component assembly is cut with the dicing blade.

FIG. 5(a) is a perspective view of a condenser microphone according to an embodiment of the present invention.

FIG. 5(b) is a sectional view of the condenser microphone shown in FIG. 5(a).

FIG. 6(a) is a sectional view of a conventional condenser microphone.

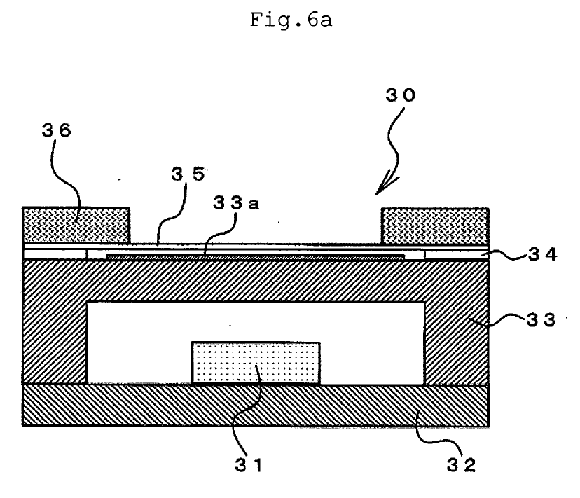

FIG. 6(b) is a perspective view of a stacked component assembly for making the conventional condenser microphone.

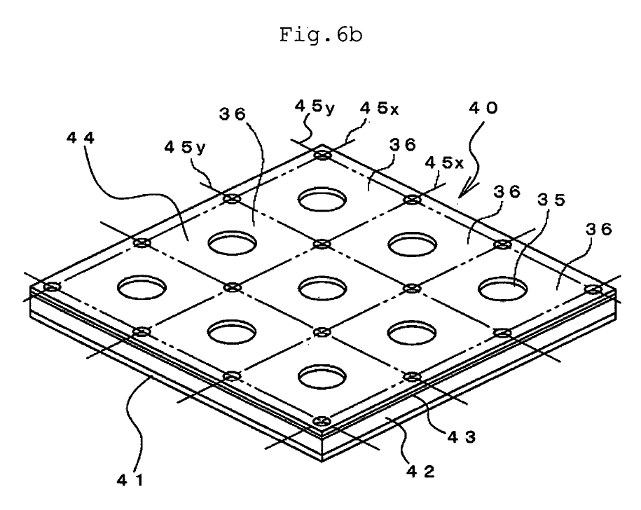

FIG. 7 is a fragmentary sectional view of a part of the conventional stacked component assembly, showing the relationship between the stacked component assembly and a dicing blade.

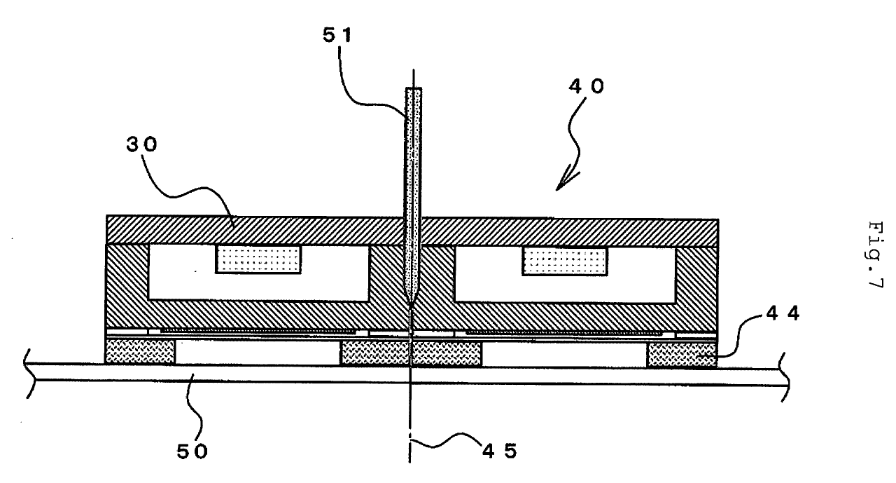

FIG. 8 is a sectional view similar to FIG. 7, showing in an enlarged view the way in which the stacked component assembly is cut with the dicing blade.

FIG. 9 is a sectional view showing problems associated with the conventional condenser microphone.

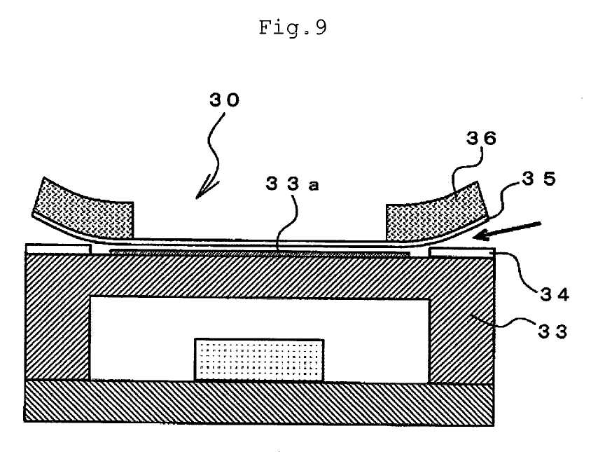

### DETAILED DESCRIPTION OF THE PREFERRED EMBODIMENTS

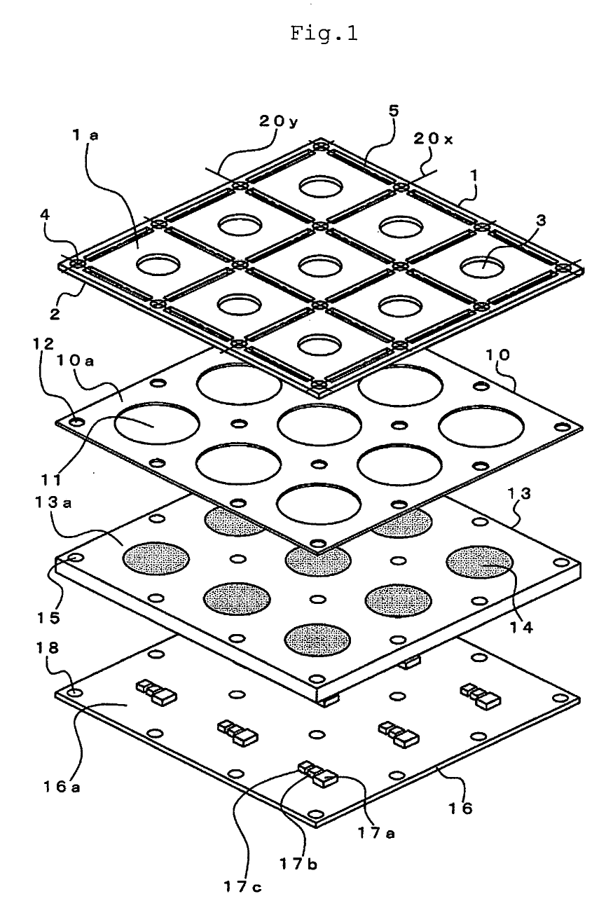

Embodiments of the present invention will be described below with reference to FIGS. 1 to 5(b).

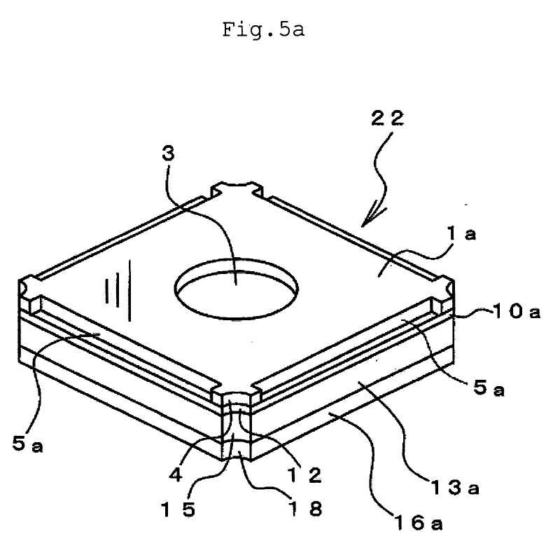

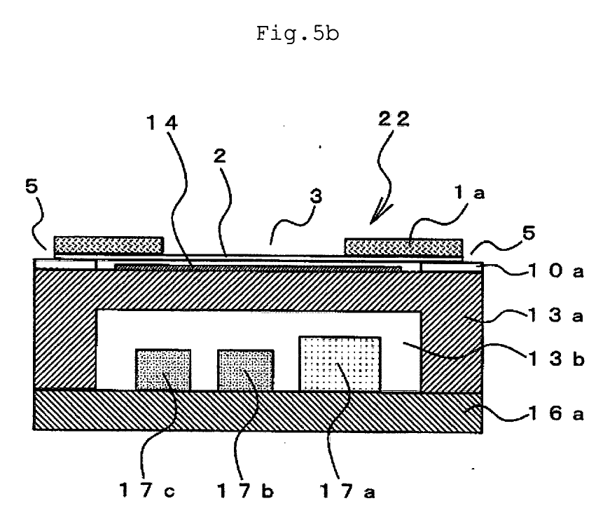

A condenser microphone 22 according to an embodiment of the present invention has, as shown in FIGS. 5(a) and 5(b), an electronic circuit board 16a, a backplate substrate 13a, a spacer 10a, and a diaphragm support frame 1a, which are successively stacked, substantially in the same way as the above-described prior art. The diaphragm support frame 1a supports a diaphragm 2 planarly. The diaphragm 2 is supported so as to be exposed in a sound collecting hole 3 provided in the diaphragm support frame 1a, as seen in a top plan view.

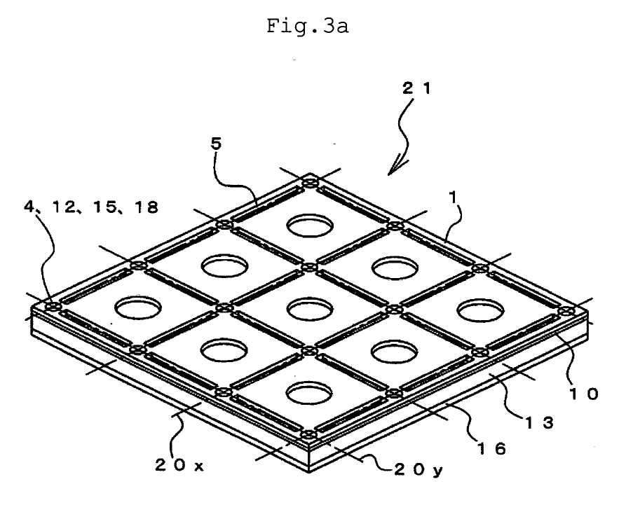

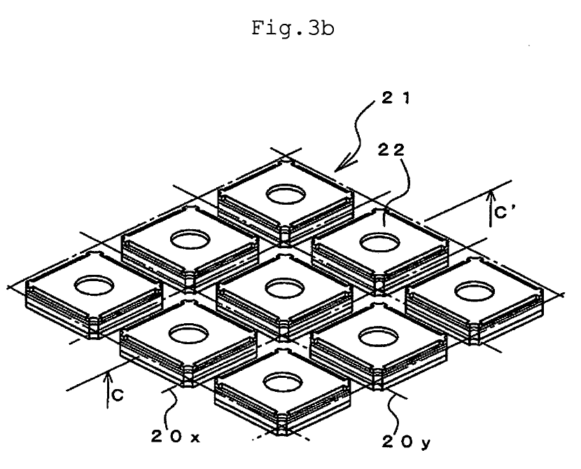

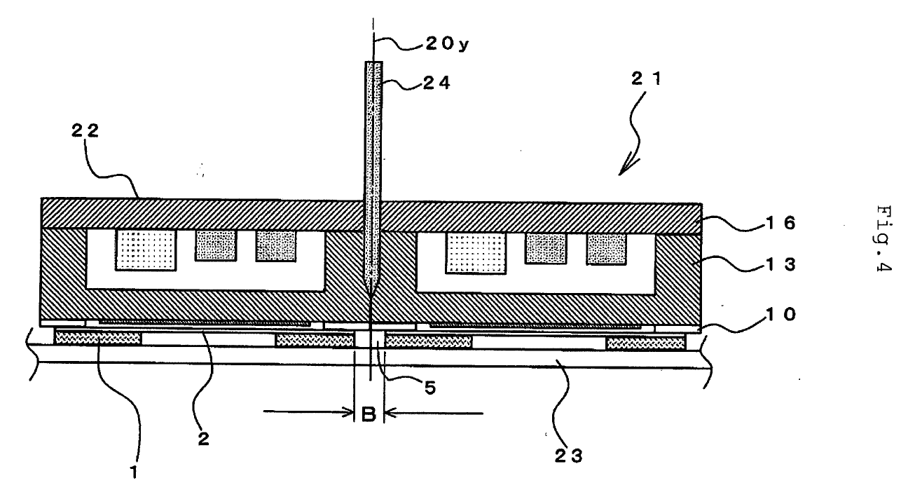

FIG. 1 is an exploded perspective view of a stacked component assembly [denoted by reference numeral 21 in FIGS. 3(a), 3(b) and 4] prepared as an intermediate product for making the condenser microphone 22 as an end product.

That is, the stacked component assembly 21 is formed by successively stacking and bonding together a diaphragm support frame assembly 1 having diaphragm support frames 1a integrally arrayed in a lattice, a spacer assembly 10 having spacers 10a integrally arrayed in a lattice, a backplate substrate assembly 13 having backplate substrates 13a integrally arrayed in a lattice, and an electronic circuit board assembly 16 having electronic circuit boards 16a integrally arrayed in a lattice.

The diaphragm support frame assembly 1 is made of a sheet-shaped metal material such as a stainless steel (hereinafter abbreviated as “SS”). More specifically, the diaphragm support frame assembly 1 has a multiplicity of diaphragm support frames 1a integrally arrayed in a lattice. A sheet is stretched on the lower side of the diaphragm support frame assembly 1 as a diaphragm assembly having a multiplicity of diaphragms 2 integrally arrayed in a lattice in correspondence to the diaphragm support frames 1a. Each diaphragm support frame 1a has a circular sound collecting hole 3 formed in the center thereof and small holes 4 formed at four corners of four sides defining the outer peripheral edge of the diaphragm support frame 1a. Each diaphragm support frame 1a further has slots 5 formed along the four sides thereof. The slots 5 are preferably formed collectively by etching process or the like. The constituent material of the diaphragm support frame assembly 1 is not necessarily limited to SS but may be aluminum, brass, nickel silver, etc.

Each spacer 10a of the spacer assembly 10 has a circular opening 11 provided in the center thereof and small holes 12 provided at four corners thereof.

Each backplate substrate 13a of the backplate substrate assembly 13 has a circular electrically conductive backplate 14 provided on the upper side thereof and small holes 15 provided at four corners thereof.

Each electronic circuit board 16a of the electronic circuit board assembly 16 has electronic elements, i.e. an FET 17a and chip condensers 17b and 17c, provided on the upper side thereof, and further has small holes 18 provided at four corners thereof. Further, the electronic circuit board 16a has formed thereon electrode patterns (not shown) for electrically connecting the FET 17a and the chip condensers 17b and 17c and for electrical connection with the backplate substrate 13a.

The diaphragm support frame assembly 1, the spacer assembly 10, the backplate substrate assembly 13 and the electronic circuit board assembly 16 are successively stacked and bonded together in such a manner that the dividing lines of these assemblies align with each other in the stacking direction, i.e. the dividing lines between the mutually contacting electronic circuit boards of the electronic circuit board assembly 16; the dividing lines between the mutually contacting backplate substrates of the backplate substrate assembly 13; the dividing lines between the mutually contacting spacers of the spacer assembly 10; and the dividing lines 20x and 20y between the mutually contacting diaphragm support frames of the diaphragm support frame assembly 1. The bonding may be carried out by using an adhesive or an adhesive sheet. If an adhesive sheet is used, one that has a configuration similar to that of the spacer assembly 10 shown in FIG. 1 should preferably be used.

The stacked component assembly 21 formed as stated above is mounted on a dicing sheet 23 in such a manner that the diaphragm support frame assembly 1 is fixed to the dicing sheet 23, and then cut with a dicing blade 24 into small pieces constituting individual condenser microphones 20. More specifically, the dicing blade 24 is set to extend in the stacking direction on the above-described dividing lines and then forced through the stacked component assembly 21 toward the dicing sheet 23, thereby cutting the stacked component assembly 21.

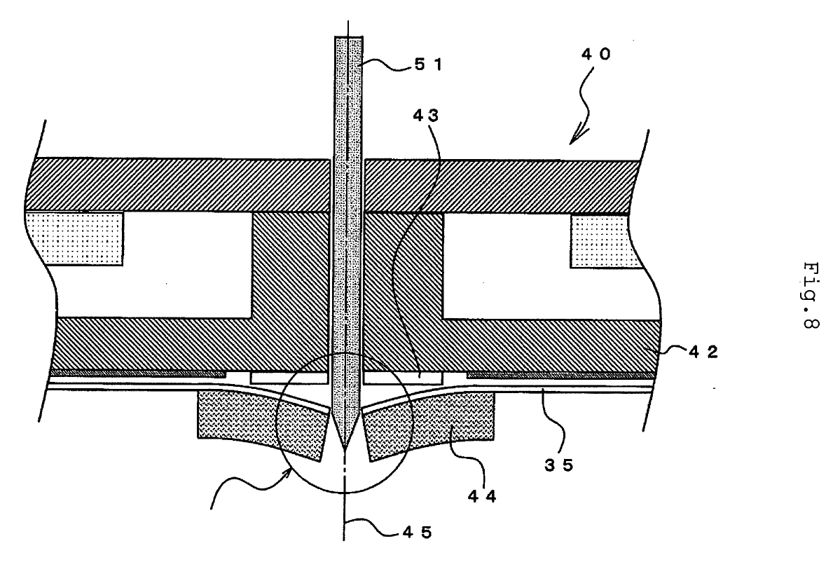

The diaphragm support frame assembly 1 is provided with the slots 5 along the dividing lines 20x and 20y, as has been stated above. The slots 5 are provided to minimize the shearing force of the dicing blade 24 applied to the diaphragm support frame 1a when the above-described cutting is performed with the dicing blade 24. Preferably, the width of the slots 5 is set somewhat wider than the thickness of the dicing blade 24. By doing so, it is possible to minimize the force applied to the diaphragm support frame 1a from the dicing blade 24 during cutting. Consequently, it is possible to avoid the problem that the diaphragm support frame assembly 1 is pressed downward, together with the diaphragm 2, by the dicing blade 24, so that the respective portions of the diaphragm support frame assembly 1 and the diaphragm 2 near the dividing line 20y separate from the spacer assembly 10 and the backplate substrate assembly 13, as in the conventional art shown in FIG. 8.

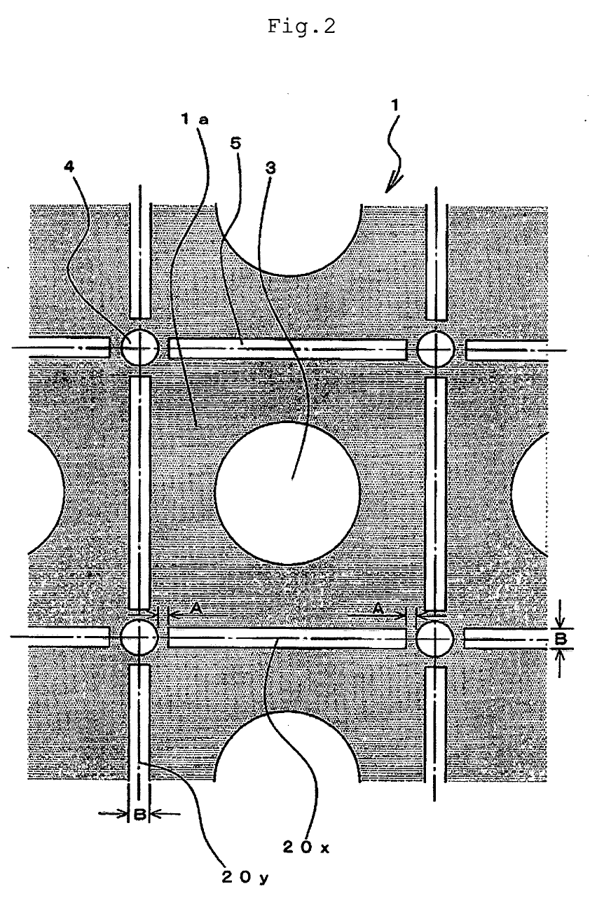

In the illustrated example, both ends of each of the slots 5 of the diaphragm support frame assembly 1, which are formed along the dividing lines 20x and 20y, are at a distance A from the respective outer peripheries of the small holes 4 close to them, as shown in FIG. 2. The distance A is preferably about 0.3 mm for an embodiment.

Although the slots 5 in this embodiment are rectangular, it should be noted that the configuration of the slots 5 is not necessarily limited thereto but may be altered at will without departing from the gist of the present invention.

FIGS. 5(a) and 5(b) show a condenser microphone 22 made from the intermediate product (i.e. stacked component assembly) 21. The condenser microphone 22 comprises a stack of a diaphragm support frame 1a, a spacer 10a, a backplate substrate 13a and an electronic circuit board 16a, which are arranged in the mentioned order from top to bottom. The condenser microphone 22 has recesses extending in the stacking direction on four corners thereof that are formed as a result of cutting the vertically superimposed small holes 4, 12, 15 and 18 to a quarter of their original size. The recesses extending in the stacking direction can be used as vias for electrically connecting the stacked diaphragm support frame 1a and backplate substrate 13a to the electronic circuit board 16a. The diaphragm support frame 1a has horizontally elongated recesses 5a on the four sides defining the outer periphery thereof, which are formed as a result of halving the slots 5.

The electronic circuit board 16a has electronic elements such as an FET 17a and chip condensers 17b and 17c mounted thereon in the same way as in the above-described conventional art. The backplate substrate 13a is provided at the lower side thereof on the electronic circuit board 16a with a recess 13b for accommodating the FET 17a and so forth. The backplate substrate 13a has a circular backplate 14 formed on the upper side thereof. The backplate 14 has an electret layer (not shown) formed on the upper side thereof from an electret dielectric film.

In this structure, the diaphragm 2 and the backplate 14 on the backplate electrode substrate 13a face each other across a slight gap to function as a capacitor. When external sound passing through the sound collecting hole 3 causes the diaphragm 2 to vibrate, the capacitance of the capacitor formed by the diaphragm 2 and the backplate 14 slightly changes. The change in capacitance is converted into an electric signal by the FET 17a, and the electric signal is output to the outside. Thus, the device functions as a microphone.

As will be understood from the above, the condenser microphone according to the present invention features that when the diaphragm support frame assembly 1 is cut with the dicing blade 24 during the manufacture of the condenser microphone, only the portions extending over the distance A, which are shown in FIG. 2, are subjected to cutting. Accordingly, it is possible to prevent the diaphragm support frame assembly 1 separating from the spacer assembly 10 by shearing force applied from the dicing blade 24 in the cutting step and also suppress the generation of heat due to friction between the dicing blade 24 and the diaphragm support frame assembly 1. Thus, it is possible to minimize the above-described problems associated with the conventional condenser microphone.

In addition, because the diaphragm support frame assembly 1 is formed from a metal material such as SS, the required strength can be ensured satisfactorily even if it is thin. Therefore, it is possible to realize a reduction in thickness of the condenser microphone. Because SS and other similar material are low in cost, the condenser microphone can be reduced in cost. Although SS used as a material of the diaphragm support frame assembly 1 has a high rigidity, wear of the dicing blade 24 is minimized because the diaphragm support frame assembly 1 is formed with the slots 5. Accordingly, the dicing blade 24 can have an extended lifetime, and the production cost can be further reduced.

It should be noted that the present invention is not necessarily limited to condenser microphones but may be readily applied to other articles manufactured by integrating a multiplicity of components to fabricate an assembly as an intermediate product and then cutting it to prepare an end product, and also applied to production methods for such articles. Although the stacked component assembly 21 in the embodiment of the present invention has a total of 9 condenser microphones 22 integrally arrayed in a lattice, the number of condenser microphones 22 is not necessarily limited to 9. In actual practice, a stacked component assembly having several hundreds of condenser microphones can be used in the manufacturing process.

It should be noted that the present invention is not necessarily limited to the foregoing embodiments but can be modified in a variety of ways without departing from the gist of the present invention.

What is claimed is:

1. A condenser microphone comprising:
an electronic circuit board;
a backplate substrate having a backplate;
a spacer; and
a diaphragm support frame supporting a diaphragm so that said diaphragm faces said backplate;
said electronic circuit board, backplate substrate, spacer and diaphragm support frame being successively stacked;
wherein outer contours of said electronic circuit board, backplate substrate and spacer are same in shape and size, and an outer contour of said diaphragm support frame has portions coincident in shape and size with the outer contours of said electronic circuit board, backplate substrate and spacer and further has recesses positioned inside the outer contours of said electronic circuit board, backplate substrate and spacer.

2. A condenser microphone according to claim 1, wherein the outer contours of said electronic circuit board, backplate substrate and spacer are quadrangular, and the outer contour of said diaphragm support frame has four sides corresponding to the outer contours of said electronic circuit board, backplate substrate and spacer, wherein at least one recess is formed along respective said four sides.

3. A condenser microphone according to claim 2, wherein each of said recesses at said four sides has an elongated-recessed shape, which extends from a center of corresponding one of said four sides to near both ends of said corresponding one.

4. A condenser microphone according to claim 3, wherein said diaphragm support frame is made of a metal material.

5. A condenser microphone according to claim 4, wherein said diaphragm support frame is made of a stainless steel.

6. A condenser microphone producing method comprising the steps of:
providing an electronic circuit board assembly having a multiplicity of quadrangular electronic circuit boards integrally arrayed in a lattice in contact with each other;
preparing a backplate substrate assembly having a multiplicity of quadrangular backplate substrates integrally arrayed in a lattice in contact with each other, said backplate substrates each having a backplate and having a same outer size as that of said electronic circuit boards;
preparing a spacer assembly having a multiplicity of quadrangular spacers integrally arrayed in a lattice in contact with each other, said spacers having a same outer size as that of said electronic circuit boards;
providing a diaphragm support frame assembly having a multiplicity of diaphragm support frames integrally arrayed in a lattice in contact with each other, said diaphragm support frame assembly having a diaphragm stretched over an entire area of one side thereof, said diaphragm support frames each having a quadrangular outer contour, said outer contour having portions coincident with the outer size of said electronic circuit board and having recesses positioned inside an outer contour of said electronic circuit board;
successively stacking and bonding together said electronic circuit board assembly, said backplate substrate assembly, said spacer assembly and said diaphragm support frame assembly in such a manner that dividing lines between the mutually contacting electronic circuit boards of said electronic circuit board assembly, dividing lines between the mutually contacting backplate substrates of said backplate substrate assembly, dividing lines between the mutually contacting spacers of said spacer assembly and dividing lines between the mutually contacting diaphragm support frames of said diaphragm support frame assembly align with each other in a stacking direction, thereby fabricating a stacked component assembly; and
cutting said stacked component assembly in said stacking direction along said dividing lines aligned with each other, thereby preparing a multiplicity of condenser microphones each having a stack of the quadrangular electronic circuit board, the quadrangular backplate substrate having the backplate, the quadrangular spacer, and the diaphragm support frame supporting the diaphragm so that said diaphragm faces said backplate.

7. A condenser microphone producing method according to claim 6, further comprising the steps of:
preparing a dicing sheet;
mounting said stacked component assembly on said dicing sheet in such a manner that an exposed-diaphragm side surface of said diaphragm support frame assembly of said stacked component assembly is fixed to said dicing sheet; and
cutting said stacked component assembly mounted on said dicing sheet with a dicing blade set to extend in said stacking direction on said dividing lines by forcing said dicing blade through said stacked component assembly toward said dicing sheet in said stacking direction.
